(19) United States
(12) Patent Application Publication
(10) Pub. No.: US 2012/0019656 A1
(43) Pub. Date: Jan. 26, 2012

(54) SYSTEM AND METHOD FOR MONITORING SUBJECTS OF INTEREST

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/868,194

(22) Filed: Aug. 25, 2010

(30) Foreign Application Priority Data
Jul. 23, 2010 (TW) 99124245

(51) Int. Cl. H04N 7/18; G06K 9/46

(52) U.S. Cl. 348/143; 382/190; 348/E07.085

(57) ABSTRACT

A system captures images of monitored subjects in a monitored area, and gives numbers to the monitored subjects according to specific features of the monitored subjects. The specific features of the monitored subjects are obtained by detecting the captured images. Only one of the numbers of each of the monitored subjects is stored, instead of repeatedly storing the numbers of same subjects. The system analyzes the stored numbers, and displays an analysis result. The system also determines a movement of each of the subjects according to corresponding numbers of the subjects.

### CROSS-REFERENCE TO RELATED APPLICATION

The present application is related to a co-pending U.S. patent application, titled “SYSTEM AND METHOD FOR MONITORING MOTION OBJECT”, with the application Ser. No. 12/507,092 (Attorney Docket No. US253950), and another co-pending U.S. patent application (Attorney Docket No. US34757), titled “SYSTEM AND METHOD FOR MONITORING MOTION OBJECT”, with the application Ser. No. 12/507,092, assigned to the same assignee as the present application, the disclosure of which is incorporated herein by reference.

### BACKGROUND

1. Technical Field

The present disclosure relates to monitoring systems and methods, and more particularly to a system and a method for monitoring subjects of interest.

2. Description of Related Art

Nowadays, video monitoring technology is prevalent in many public spaces, such as banks, stores, and parking lots. Moving objects may be detected during video monitoring, and recorded data may be obtained for analysis. For example, video monitoring technology has been proposed to measure traffic flow on highways by recording the number of vehicles passing through the monitored areas of the highways. In addition, video monitoring technology is helpful to compile consumer demographics in shopping malls and amusement parks by detecting and counting consumers who traverse into a monitored area during a predetermined time period. However, there are times that users may not want to repeatedly record or count the same motion objects which appear in a monitored area many times during a given period of time.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an embodiment of a system for monitoring subject of interest, the monitoring system includes an image generating device, and a storage device.

FIG. 2 is a block diagram of the image generating device of FIG. 1.

FIG. 3 is a block diagram of an information gathering module of the storage device of FIG. 1.

FIG. 4 is a block diagram of a processing module of the storage device of FIG. 1.

FIG. 5 is a flowchart of an embodiment of a method for monitoring subjects of interest.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

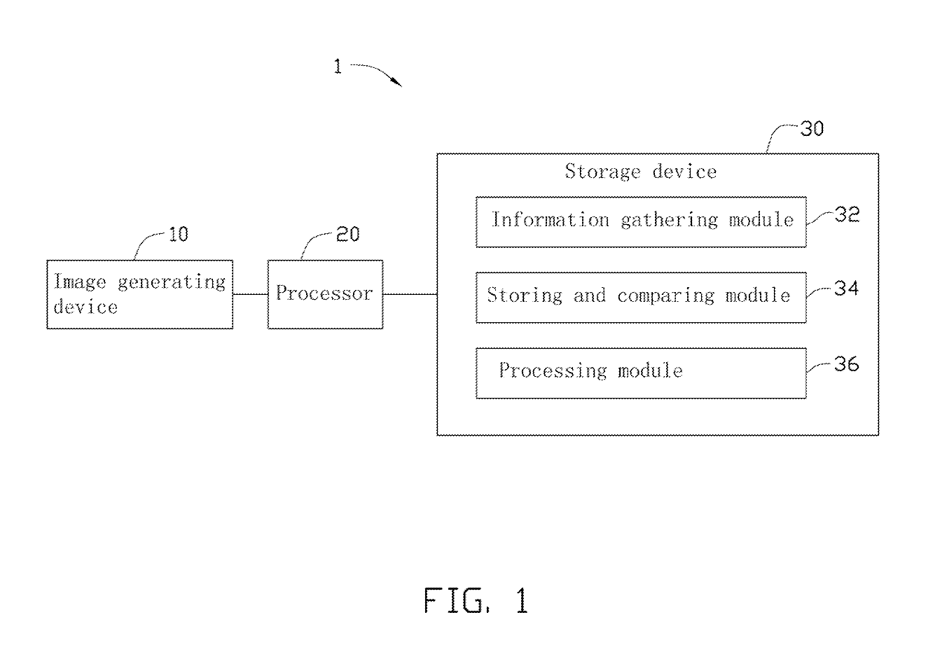

Referring to FIG. 1, an embodiment of a system 1 includes an image generating device 10, a processor 20, and a storage device 30. The storage device 30 includes an information gathering module 32, a storing and comparing module 34, and a processing module 36. The information gathering module 32, the storing and comparing module 34, and the processing module 36 may include one or more computerized instructions and are executed by the processor 20. The system 1 is operable to detect monitored subjects in a monitored area, give numbers about the monitored subjects, and analyze the given numbers of the monitored subjects.

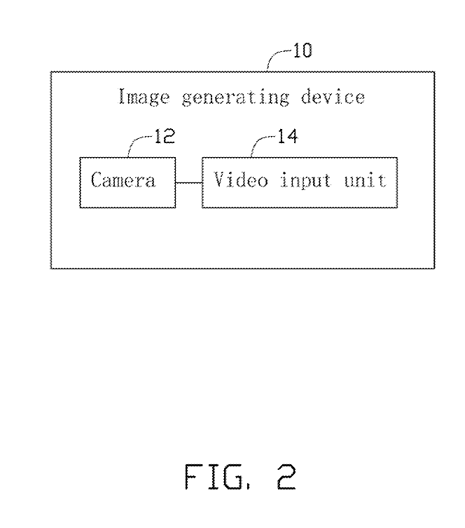

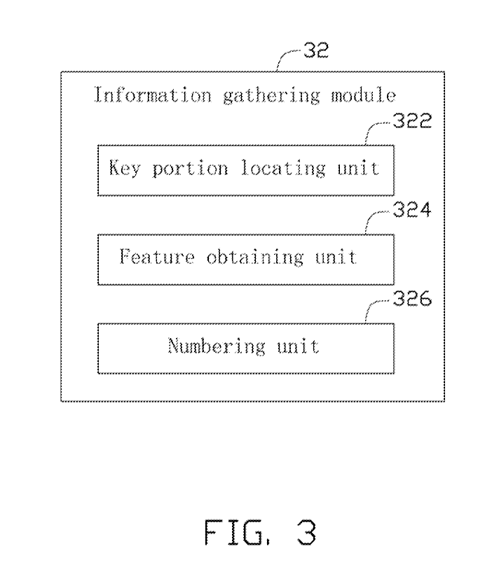

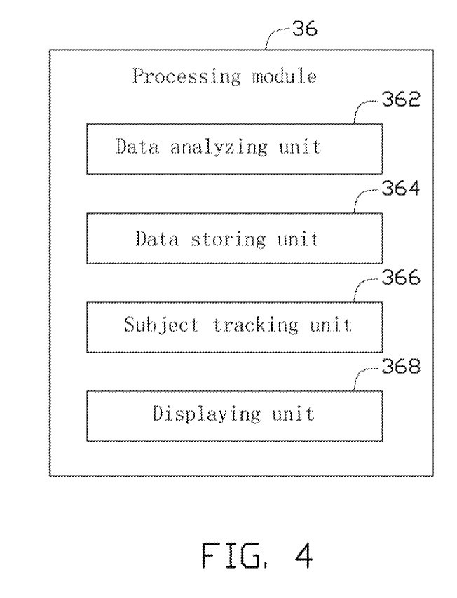

Referring to FIGS. 2 to 4, the image generating device 10 includes an image capturing device, such as a camera 12, and a video input unit 14. The information gathering module 32 includes a key portion locating unit 322, a feature obtaining unit 324, and a numbering unit 326. The processing module 36 includes a data analyzing unit 362, a data storing unit 364, a subject tracking unit 366, and a displaying unit 368.

The camera 12 captures images of subjects in the monitored area. The video input unit 14 transmits the captured images to the information gathering module 32 through the processor 20. The key portion locating unit 322 of the information gathering module 32 locates key portions of each of the captured images by detecting the captured images. The key portions of the captured images may have specific features of the monitored subjects, such as facial and physique features of humans. In this embodiment, the key portions of each of the captured images may include faces and statures of the subjects. The feature obtaining unit 324 obtains facial and physique features of each of the subjects by detecting faces of the subjects in the captured images. The facial features may include face shapes, complexions, and features of individual sense organs, such as features of ears, eyes, lips, or noses of the subjects. The physique feature may includes statures of the subjects. The numbering unit 326 gives a number to each of the subjects according to the facial and physique features of the subjects. Each of the numbers may include a feature portion representing individual facial features of a subject, a position portion representing a coordinate position of the subject in the monitored area, and a time portion representing a time when the subject appears at the coordinate position. Therefore, a plurality of numbers may be given to a same subject when the subject appears at different coordinate positions, or different times in the monitored area in a time period. The feature portions of the numbers of a same subject are the same.

The given numbers of the subjects are received by the storing and comparing module 34. When a new number is received by the storing and comparing module 34, the feature portion of the new number is compared with the feature portions of the stored numbers in the storing and comparing module 34. The storing and comparing module 34 stores the new number when the feature portion of the new number is different from the feature portion of each of the stored numbers. The new number is not stored by the storing and comparing module 34 when the feature portion of the new number is the same to a feature portion of a stored number. Therefore, only one of given numbers of a same subject appears in the monitored area in the time period can be stored by the storing and comparing module 34.

The time period can be predetermined according to need, such as 10 minutes or 5 hours. The stored numbers are transmitted to the data analyzing unit 362 for analysis. For example, the stored numbers may be counted by the data analyzing unit 362 to obtain the number of customers which enter a supermarket from 9:00 am. to 5:00 pm. of a day. Each of the customers cannot be repeatedly counted. An analysis result of the stored numbers may be transmitted to the displaying unit 368 from the data analyzing unit 362. The displaying unit 368 displays the analysis result.

The position portion of the given number of each of the subjects is formed in coordinate information, representing the coordinate position of each of the subject in the monitored area. All of the given numbers are transmitted to the data storing unit 364 by the numbering unit 326. The data storing unit 364 stores the given numbers of the subjects. Each of the subjects can be tracked by the subject tracking unit 366. The subject tracking unit 366 may read the position portions and the time portions of given numbers which include same feature portions, from the data storing unit 364, and sequence the position portions of the given numbers of each of the subjects according to the time portions. The position portions of each of the subjects are displayed on the displaying unit 368. Therefore, the displaying unit 368 can display the coordinate positions of a subject in sequence of times. Thus, the movement of a subject can be surveyed from the displaying unit 368.

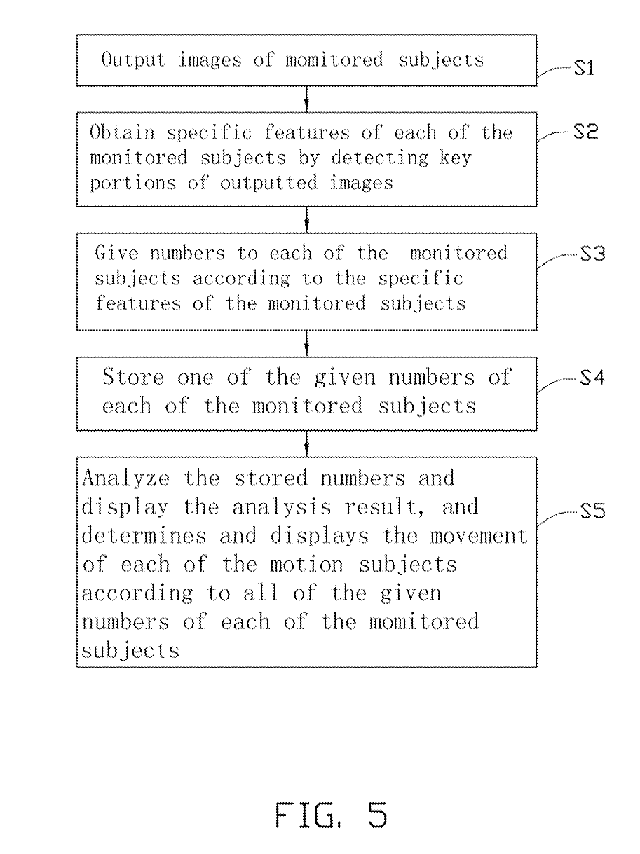

Referring to FIG. 5, an embodiment of a subject monitoring method includes the following steps.

In step S1, the video input unit 14 receives the captured images of monitored subjects from the camera 12, and transmits the captured images to the information gathering module 32.

In step S2, the information gathering module 32 obtains the specific features of each of the monitored subjects by detecting the key portions of the captured images. As mentioned above, the key portions of the captured images are located by the key portion locating unit 322, and detected by the feature obtaining unit 324. The key portions of each of the captured images may include a face and a stature. The specific features of the monitored subjects may be facial and physique features, such as face shapes and statures.

In step S3, the information gathering module 32 gives a number to each of the monitored subjects according to the specific features of the monitored subjects. Each of the numbers includes the feature portion, the time portion, and the position portion. The feature portions of the numbers of a same subject are the same. The numbers of the monitored subjects are generated by the numbering unit 326.

In step S4, the storing and comparing module 34 receives the given numbers, and stores only one of the given numbers of each of the monitored subjects. In this embodiment, the storing and comparing module 34 stores a new number when the feature portion of the new number is different from the feature portion of each of the stored numbers. The new number is not stored by the storing and comparing module 34 when the feature portion of the new number is the same to the feature portion of one of the stored numbers.

In step S5, the stored numbers and all of the given numbers are received by the processing module 36 to be analyzed respectively. In this step, the stored numbers are received by the data analyzing unit 362 from the storing and comparing module 34. The stored numbers may be counted by the data analyzing unit 362, and an analysis result of the stored numbers may be displayed by the displaying unit 368. The given numbers are received by the data storing unit 364 from the numbering unit 326. The feature portions, the time portions, and the position portions of the given numbers are helpful to survey the movement of the monitored subjects. The displaying unit 368 can display the coordinate positions of each of the subjects in sequence of times.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A system to monitor subjects of interest, comprising:
an image generating device outputting a plurality of images of monitored subjects appearing in a monitored area in a predetermined time period;
a processor; and
a storage device connected to the processor and storing one or more computerized instructions to be executed by the processor, wherein the storage device comprises:
an information gathering module obtaining specific features of the monitored subjects by detecting the outputted images, and giving numbers to each of the monitored subjects according to the specific features, each given number comprising a feature portion representing the specific feature of a corresponding one of the monitored subjects;
a storing and comparing module storing one of the given numbers of each of the monitored subjects, and comparing the feature portion of a given number with the feature portion of each of the stored numbers in response to receipt of the given number, wherein the storing and comparing module stores the given number if the feature portion of the given number is different from the feature portion of all of the stored numbers; and
a processing module comprising a data analyzing unit analyzing the given numbers stored in the storing and comparing module to obtain an analysis result.

2. The system of claim 1, wherein the given number is not stored in the storing and comparing module if the feature portion of the given number is the same as the feature portion of one of the stored numbers.

3. The system of claim 1, wherein each of the given numbers further comprises a position portion representing a coordinate position of the monitored subject in the monitored area, and a time portion representing a time when the monitored subject appears at the coordinate position.

4. The system of claim 3, wherein the processing module comprises:
a data storing unit receiving the given numbers from the information gathering module, and storing the given numbers;
a subject tracking unit reading the position portions and the time portions of the given numbers with same feature portions, from the data storing unit, and sequencing the position portions according to the time portions correspondingly; and
a displaying unit displaying the coordinate positions in sequence of time according to the sequenced position portions.

5. The system of claim 1, wherein the image generating device comprises:
an image capturing device capturing the images of monitored subjects; and
a video input unit transmitting the captured images to the information gathering module.

6. The system of claim 1, wherein the information gathering module comprises:
a key portion locating unit locating key portions which have the specific features of the monitored subjects in each of the images;
a feature obtaining unit obtaining the specific features by detecting the key portions of each of the images; and
a numbering unit generating the numbers for the monitored subjects according to the detected specific features.

7. The system of claim 6, wherein the key portions of each of the images comprise faces and stature of the subjects, the specific features of the monitored subjects comprise facial and physique features of the subjects.

8. A method comprising:
transmitting a plurality of images of subjects in a monitored area to an information gathering module from an image generating device;
obtaining specific features of each of the subjects by detecting the plurality of images by an information gathering module;
giving numbers to each of the subjects according to the specific features of the subjects, wherein each of the given numbers comprises a feature portion representing specific features of a corresponding one of the subjects;
storing one of the given numbers of each of the subjects by a storing and comparing module;
receiving a number by the storing and comparing module;
comparing the feature portion of the received number with the feature portion of each of the stored numbers by the storing and comparing module, wherein the storing and comparing module stores the received number if the feature portion of the received number is different from the feature portion of all of the stored numbers;
counting the stored given numbers by a data analyzing unit of the processing module; and
displaying a counting result of the stored given numbers by a displaying unit of the processing module.

9. The method of claim 8, wherein the step of obtaining specific features of each of the subjects comprises:
locating key portions of each of the plurality of images by a key portion locating unit of the information gathering module; and
obtaining the specific features by detecting the key portions of each of the plurality of images by a feature obtaining unit of the information gathering module.

10. The method of claim 8, wherein the numbers of each of the subjects are generated by a numbering unit of the information gathering module.

11. The method of claim 8, wherein in the step of comparing the feature portion of the received number with the feature portion of each of the stored numbers by the storing and comparing module, the received number is not stored in the storing and comparing module if the feature portion of the received number is the same as the feature portion of one of the stored numbers.

12. A method comprising:
transmitting a plurality of images of subjects in a monitored area to an information gathering module from an image generating device;
giving numbers to the subjects by an information gathering module, wherein each of the numbers of each of the subjects comprises a feature portion representing specific features of the subject, a position portion representing a coordinate position of the subject in the monitored area, and a time portion representing a time when the subject appears at the coordinate position;
storing the given numbers in a data storing unit;
reading the position portions and the time portions of the given numbers with same feature portions from the data storing unit, and determining a movement of each of the subjects by sequencing the position portions according to corresponding time portions by a subject tracking unit; and
displaying the movement of each of the subjects by a displaying unit.
